(19) United States
(12) Patent Application Publication
(10) Pub. No.: US 2024/0337444 A1
(43) Pub. Date: Oct. 10, 2024

(54) HOLDING DEVICE FOR HOLDING A CERAMIC ANCHOR BRICK TO A FURNACE WALL, A FURNACE COMPRISING SUCH A HOLDING DEVICE, AND A METHOD FOR FASTENING SUCH A HOLDING DEVICE TO A FURNACE WALL

(71) Applicant: REFRACTORY INTELLECTUAL PROPERTY GMBH & CO. KG, Wien (AT)

(72) Inventors: Bernhard HANDLE, Wien (AT); Bojan ZIVANOVIC, Wien (AT)

(21) Appl. No.: 18/564,589

(22) PCT Filed: May 23, 2022
(86) PCT No.: PCT/EP2022/063923

§ 371 Date: Jun. 24, 2024

(30) Foreign Application Priority Data
May 27, 2021 (EP) 21176157.2

(51) Int. Cl. F27D 1/14; F27D 1/00

(52) U.S. Cl. CPC F27D 1/141; F27D 2001/0079

(57) ABSTRACT

A holding device (1) for holding a ceramic anchor brick (300) to a furnace wall (10), the holding device (1) comprising:
fastening means (100) for fastening the holding device (1) to a furnace wall (10); a receiving part (200) for holding a ceramic anchor brick (300) to the holding device (1); wherein the fastening means (100) comprise a first fastening part (101) and a second fastening part (102), wherein the first fastening part (101) is fastenable to a furnace wall (10), and the second fastening part (102) is fastenable to the receiving part (200), and wherein the second fastening part (102) is fastenable to the first fastening part (101), characterized in that the first fastening part (101) and the second fastening part (102) are designed in such a way that the second fastening part (102) can be fastened to the first fastening part (101) by a relative movement of the second fastening part (102) to the first fastening part (101).

The invention relates to a holding device for holding a ceramic anchor brick to a furnace wall, a furnace comprising such a holding device, and a method for fastening such a holding device to a furnace wall.

Holding devices with a ceramic anchor brick held to them are used to hold a refractory lining of an industrial furnace. In the prior art, a ceramic anchor brick is occasionally referred to simply as a “ceramic anchor”.

The refractory lining of the industrial furnace, which can be supported by the ceramic anchor brick, can in particular be a refractory ceramic lining. Such a refractory ceramic lining may be in the form of an unshaped refractory material, for example in the form of a ceramic mass, or in the form of a shaped ceramic material, for example in the form of bricks. The refractory lining is arranged with respect to the ceramic anchor brick in such a way that it can be held in a desired position by the ceramic anchor brick. In particular, it is known that the ceramic anchor brick is profiled on its surface, with the refractory lining engaging in this profiling in such a way that it can be held by the ceramic anchor brick. The ceramic anchor brick, in turn, is held on the furnace wall by a holding device fastened to the furnace wall.

For fastening the holding device to the furnace wall, such a holding device regularly has fastening means. Furthermore, the holding device has a receiving part for holding the ceramic anchor brick on the holding device. In this context, the ceramic anchor brick can have a receiving section which can be received in a receptacle of the receiving part for retaining the anchor brick on the receiving part. The receiving parts known from the prior art regularly have a claw-like shape which embraces the receiving section of the anchor stone.

A generic holding device is disclosed, for example, in EP 2 322 889 B1.

Particularly during heating and cooling of the industrial furnace, but also during ongoing operation of the industrial furnace, the holding device is subject to considerable temperature fluctuations, which lead to thermal expansion and shrinkage of the holding device. The holding device must therefore be designed in such a way that it is able to absorb thermal expansions of the holding device.

In order to be able to absorb thermal expansions by the holding device, it is known to provide a fastening means comprising a first fastening part and a second fastening part, wherein the first fastening part can be fastened to a furnace wall, and the second fastening part is fastened to the receiving part, and wherein the second fastening part can be fastened to the first fastening part. Through this, the first and second fastening parts can be designed to be movable relative to each other, whereby thermal expansions of the holding device can be absorbed. The fastening of the first fastening part to the second fastening part presents a particular challenge, since the second fastening part should on the one hand be securely fastenable to the first fastening part, but at the same time the aforementioned movability of the first and second fastening parts relative to each other should be given. According to EP 2 322 889 B1, a receiving means holding the anchor brick is fastened to a retaining web which can be fastened to a furnace wall by means of a set screw which can be melted during furnace operation. However, such a fastening via a set screw to be screwed in is complicated. Further, such fastening is not secure unless the set screw is tightened. Finally, it is disadvantageous that when the refractory lining is removed after the furnace has been operated, for example for repair of the lining, the holding means is no longer fastened to the holding web, since the set screw has then already melted and thus become unusable for further use.

It is an object of the present invention to provide a holding device for holding a ceramic anchor brick on a furnace wall, by means of which thermal expansions of the holding device can be absorbed during furnace operation, and which at the same time can be easily and securely fastened to the furnace wall. Furthermore, it is an object of the invention to provide such a holding device which always allows secure fastening of the holding device to the furnace wall even if a refractory lining is removed from the anchor brick after furnace operation, for example during repair of the lining.

To solve this problem, according to the invention, there is provided a holding device for holding a ceramic anchor brick on a furnace wall, wherein the holding device comprises:
Fastening means for fastening the holding device to a furnace wall;
a receiving part for holding a ceramic anchor brick on the holding device;
wherein the fastening means comprises a first fastening part and a second fastening part, wherein the first fastening part is fastenable to a furnace wall, and the second fastening part is fastenable to the receiving part, and wherein the second fastening part is fastenable to the first fastening part;
and further wherein the first fastening part and the second fastening part are designed in such a way that the second fastening part is fastenable to the first fastening part by a relative movement of the second fastening part to the first fastening part.

The invention is based on the surprising finding that a holding device can be provided which solves the aforementioned objects if it comprises a first fastening part and a second fastening part, the first fastening part being fastenable to a furnace wall and the second fastening part being fastenable to the receiving part, the second fastening part furthermore being fastenable to the first fastening part, and the first fastening part and the second fastening part at the same time being designed in such a way that the second fastening part is fastenable to the first fastening part by a movement of the second fastening part relative to the first fastening part. In this respect, according to the invention, it has been found, in particular surprisingly, that the fastening of the holding device to a furnace wall is particularly simple in that, for this purpose, only the second fastening part can be fastened to the first fastening part by a relative movement thereto. In particular, the necessity of having to use further aids, such as screws or the like, for fastening the second fastening part to the first fastening part is eliminated in this respect. Furthermore, it has surprisingly been found in accordance with the invention that by means of such a fastening the holding device can at the same time be fastened particularly securely to the furnace wall. This is because a relative movement of the second fastening part with respect to the first fastening part is again necessary for releasing the fastening. Finally, by comprising a first and a second fastening part, the holding device can absorb thermal expansions during furnace operation.

According to a particularly preferred embodiment, the relative movement is a rotary movement.

A particular advantage of such a relative movement in the form of a rotary movement is that it can be carried out particularly easily and, in particular, without taking up much space. This can be the case in particular in confined spaces on a furnace wall. In this respect, such a relative movement in the form of a rotary movement can be clearly superior in particular to a relative movement in the form of a straight-line movement, since a straight-line movement can be disadvantageous in particular in cramped spatial conditions.

In particular, however, it has also been found in accordance with the invention that a relative movement in the form of a rotary movement is particularly advantageous insofar as a particularly secure fastening can be achieved by this. In particular, this is also due to the fact that in order to release the fastening, which was achieved by means of such a rotary movement, a rotary movement must in turn be performed, which is generally not performed unintentionally. In this respect, the second fastening part can be fastened particularly securely to the first fastening part, in particular by means of a rotary movement, without this fastening subsequently being able to be released again unintentionally.

According to one embodiment, it may be provided that the relative movement for fastening the first fastening part to the second fastening part requires a rotary movement with a rotary angle in the range from 10° to 170°. According to the invention, however, it was found that a particularly secure fastening of the second fastening part to the first fastening part can be achieved if the relative movement requires a rotary movement with a rotary angle of 90° or a rotary angle as close as possible to 90°. In this respect, a rotary angle in the range from 30° to 150°, from 60° to 120° or in the range from 80° to 100° can also preferably be required for fastening.

In this respect, the first fastening part and the second fastening part can be designed in such a way that the second fastening part is fastenable to the first fastening part by a rotary movement with a rotary angle of the second fastening part relative to the first fastening part as set forth hereinbefore.

According to a particularly preferred embodiment, it may be provided that the first fastening part and the second fastening part are configured in such a way that the second fastening part (after fastening of the second fastening part to the first fastening part according to the invention) can be detached from the first fastening part by a second relative movement to the first fastening part. According to a particularly preferred further embodiment of this inventive idea, it may be provided that the second fastening part is releasable from the first fastening part again by a relative movement opposite to the relative movement. In other words, the second fastening part can be fastened to the first fastening part by a first relative movement of the second fastening part to the first fastening part, and further the second fastening part can be detached from the first fastening part by a second relative movement of the second fastening part to the first fastening part, wherein the second relative movement is preferably opposite to the first relative movement.

In the sense of the aforementioned idea of the invention, according to which the second fastening part is detachable from the first fastening part to the extent that the second fastening part is detachable from the first fastening part by an opposite relative movement, it may in this respect again preferably be provided that the second fastening part is detachable from the first fastening part by an opposite rotary movement. In particular, it can be provided in this respect that the second fastening part is fastenable to the first fastening part by a first rotary movement with a rotary angle as above in a first rotary direction of the second fastening part relative to the first fastening part, and further that the second fastening part is detachable from the first fastening part by a second rotary movement with a rotary angle according to the first rotary movement but in a rotary direction of the second fastening part relative to the first fastening part opposite to the first rotary direction.

According to a preferred embodiment, the first fastening part is formed in one piece. The first fastening part is preferably made of metal, particularly preferably of steel. The first fastening part can be fastened to the furnace wall, for example by means of a material bond or a form-fit, i.e., for example by welding or a screw connection. Preferably, the first fastening part is designed in such a way that it can be fastened to the furnace wall protruding from the furnace wall. This has the particular advantage that the second fastening part can subsequently be fastened to the first fastening part with particular ease. Particularly preferably, the first fastening part can be designed in a bridge-like or web-like manner for this purpose. Such a bridge-like or web-like first fastening part, in particular insofar as it is also made in one piece and in particular of steel, can be of particularly robust design, can be easily fastened to the furnace wall and, furthermore, the second fastening part can be fastened particularly easily to such a first fastening part.

According to a preferred embodiment, the second fastening part is formed in one piece. The second fastening part can preferably be made of metal, particularly preferably of steel. According to a further embodiment of this inventive idea, the second fastening part and the receiving part can be formed together in one piece. In this embodiment, the second fastening part and the receiving part can thus be formed as a one-piece part, in particular as a one-piece metal part, particularly preferably as a one-piece steel part. This has the particular advantage that the fastening part and the receiving part can be of particularly simple and robust design. Furthermore, this also has the particular advantage that the receiving part does not have to be fastened separately to the second fastening part. This also has a particular advantage when a ceramic anchor brick is received in the receiving part, since once the ceramic anchor brick has been received in the receiving part, the second fastening part, the receiving part and the ceramic anchor stone form a common element that can be fastened particularly easily to the first fastening part.

According to one embodiment, it is provided that the second fastening part is form-fitting fastenable to the first fastening part by a relative movement of the second fastening part to the first fastening part. Such a form-fitting fastening also has the particular advantage that the second fastening part is secured against unintentional detachment from the first fastening part, for example in the event of accidental impact against the second fastening part during its installation on the furnace wall or also during furnace operation.

In order to be able to achieve such a form fit between the second fastening part and the first fastening part, it can be provided, for example, that the second fastening part has a section which can be inserted into the first fastening part and by means of which the first fastening part can be fastened to the first fastening part in a form-fitting manner. According to a preferred embodiment, it can be provided that the first fastening part has an insertion opening and the second fastening part has an insertion section that can be inserted into the insertion opening, and wherein the second fastening part can be form-fitting fastened to the first fastening part via the insertion section inserted into the insertion opening by the relative movement of the second fastening part. In particular, according to a further development of this inventive idea, it can be provided that the second fastening part is form-fitting fastened to the first fastening part as long as the insertion section is not again in its initial position, i.e., in the position in which it was located when it was inserted into the insertion opening, i.e., before the relative movement was carried out. In particular, such a relative movement by which the insertion section can be fixed in the insertion opening can be a rotary movement. In this respect, this embodiment resembles the principle of a key and a lock. According to this, the first fastening part has an insertion opening (a “lock”) into which the insertion section (a “key”) of the second fastening part can be inserted and is then positively held in the insertion opening by a rotary movement (like a key in a lock, as long as the key is turned in the lock and is not in its initial position again). The insertion section can then only be removed from the insertion opening when the insertion section is in its initial position.

According to a preferred embodiment, the insertion opening is a slot with an undercut. The insertion section can be inserted into the slot and the undercut can be engaged behind by the insertion section through the relative movement, in particular a rotary movement. In this way, the insertion section is form-fitting fastened in the slot and at the same time locked against loosening. The second fastening part can be fastened particularly easily and securely to the first fastening part by means of correspondingly designed fastening parts. A particularly simple and effective further development of this inventive idea is that the slot is an elongated hole with an undercut.

According to a further development of the above invention, the insertion section can be T-shaped. In this case, the T-shaped insertion section can be fastened to the receiving part with its base leg (i.e., the vertical leg of the T) and can be inserted into the slot with its transverse leg (i.e., the horizontal leg of the T), and the undercut can be gripped behind by the transverse leg as a result of the relative movement.

The receiving part of the holding device for holding a ceramic anchor brick on the holding device can be designed according to the state of the art. In this respect, the receiving part is designed in such a way that a ceramic anchor brick can be held on it.

According to one embodiment, a ceramic anchor brick is held in the receiving part. The anchor brick is made of a ceramic material, preferably a refractory ceramic material. In particular, the ceramic anchor brick may comprise a ceramic material known from the prior art for ceramic anchor bricks.

According to a particularly preferred embodiment, it is provided that the first fastening part is frictionally fastened to the second fastening part. According to a particularly preferred embodiment, it is provided that the first fastening part is frictionally fastened to the second fastening part by a fixing means. In this respect, in particular, a fixing means may be provided which loses its fixing effect at the temperatures prevailing in the region of the receptacle during use of the holding device in furnace operation. Preferably, the fixing means can in this respect lose its fixing effect at temperatures above 80° C., preferably at temperatures in the range from 80 to 300° C. and particularly preferably at temperatures in the range from 80 to 200° C. For example, the fixing means may comprise a material that decomposes, ignites or melts at these temperatures, or a combination of several such materials.

A particular advantage of such a fixing means, by which the second fastening part is frictionally fixed to the first fastening part, is in particular that the first and second fastening parts can initially be frictionally fixed to each other simply and securely during the arrangement of the holding device on a furnace wall, so that loosening of the fastening of the second fastening part to the first fastening part can be prevented. However, if subsequently during use of the holding device in furnace operation (i.e., during heating of the furnace and ongoing operation) the fixing means loses its frictional effect (i.e., for example by the fixing means burning out or melting), the first and second fixing parts are movable relative to each other at least to a certain extent, whereby in particular also thermally induced elongations can be absorbed and thermally induced stresses can be relieved.

According to a preferred embodiment, the fixing means is in the form of a plate.

In particular, to the extent that the fixing means is in plate form, it may preferably have a thickness in the range of 1 to 10 mm, more preferably a thickness in the range of 1 to 5 mm, and even more preferably a thickness in the range of 3 to 5 mm.

Particularly preferably, the fixing means consists of compressible, especially preferably elastically compressible material. Such an elastically compressible material is compressible against the elastic force of the material. Due to this elasticity of the second fixing means, the second fixing part can be fixed to the first fixing part in a particularly simple and secure manner with frictional engagement. For in this respect, it can be provided that the relative movement of the second fastening part to the first fastening part in order to fasten the second fastening part to the first fastening part according to the invention takes place while exerting a force against the elastic force of the second fixing means. After the second fastening part has been fastened, the first fastening part and the second fastening part are subsequently frictionally connected to one another by the elastic force of the second fixing means, as set out above.

According to a particularly preferred embodiment, the fixing means comprises material which melts at the temperatures prevailing in the region of the first and second fixing members during use of the holding device in oven operation. According to a further embodiment of this invention, such material may comprise a plastic, preferably a thermoplastic plastic, particularly preferably for example one of the following thermoplastics: Polyethylene or Polypropylene.

In order to make the fixing means appropriately compressible, the fixing means can, for example, consist entirely or partially of elastically compressible material, for example, of an elastically compressible plastic, for example, a foamed thermoplastic plastic, in particular a thermoplastic plastic formed as above, rubber, bitumen, cardboard, paperboard or a combination of several of these materials. For example, the second fixing means may also comprise only partially such an elastically compressible material and further comprise a non-compressible material, for example in the form of a composite material. Such a composite material may, for example, be formed of a first elastically compressible material and a second non-compressible material. Such an embodiment will be explained in more detail in the figure description.

According to a particularly preferred embodiment, the second fastening part is attached to the first fastening part both (as described in more detail above) by form-fitting locking and (as described in more detail above) by frictional locking.

It is also an object of the invention to provide a furnace comprising the following features:
A furnace wall,
one or more of the holding devices according to the invention, wherein the holding devices are each fastened to the furnace wall via the fastening means.

In this case, the holding devices can be fastened to the furnace wall via the fastening means, as explained above.

The furnace according to the invention is in particular an industrial furnace, for example a heating furnace or a rotary furnace. In particular, the furnace according to the invention is an industrial furnace designed for the temperature treatment of goods, in particular for the production of starting materials for the basic materials or consumer goods industry, at over 600° C., preferably also at over 1,000° C. and in particular also at over 1,200° C.

According to the invention, the furnace according to the invention can be further characterized in that it also has a furnace ceiling, the holding devices according to the invention being fastened to the furnace ceiling via the fastening means.

It is also an object of the invention to provide a method of fastening one or more holding devices according to the invention to a furnace wall of a furnace, in particular a furnace according to the invention, comprising the following steps:
Fastening the first fastening part to the furnace wall;
Performing relative movement of the second fastening part to the first fastening part to fasten the second fastening part to the first fastening part

As described above, the first fastening part can be fastened to the furnace wall, for example, by means of a material bond or a form fit, i.e., it can be welded or screwed to the furnace wall. Then, the second fastening part can then be fastened to the first fastening part. Thereby, the second fastening part is fastened to the first fastening part by a relative movement of the second fastening part to the first fastening part.

As explained above, the relative movement can be a rotary movement, in particular with the angles of rotation described in more detail above.

In order to fasten the second fastening part to the first fastening part, the second fastening part can also be inserted into the first fastening part, whereby, as explained above, the second fastening part can in particular have an insertion section that can be inserted into an insertion opening of the first fastening part. Preferably, it can be provided that, when carrying out the method according to the invention, first the first fastening part is fastened to the furnace wall and then the second fastening part is inserted into the first fastening part. Subsequently, the relative movement of the second fastening part to the first fastening part can be carried out.

Further features of the invention are apparent from the claims, the figures and the following description of figures.

All of the features of the invention, individually or in combination, may be combined in any manner.

In the figures shows

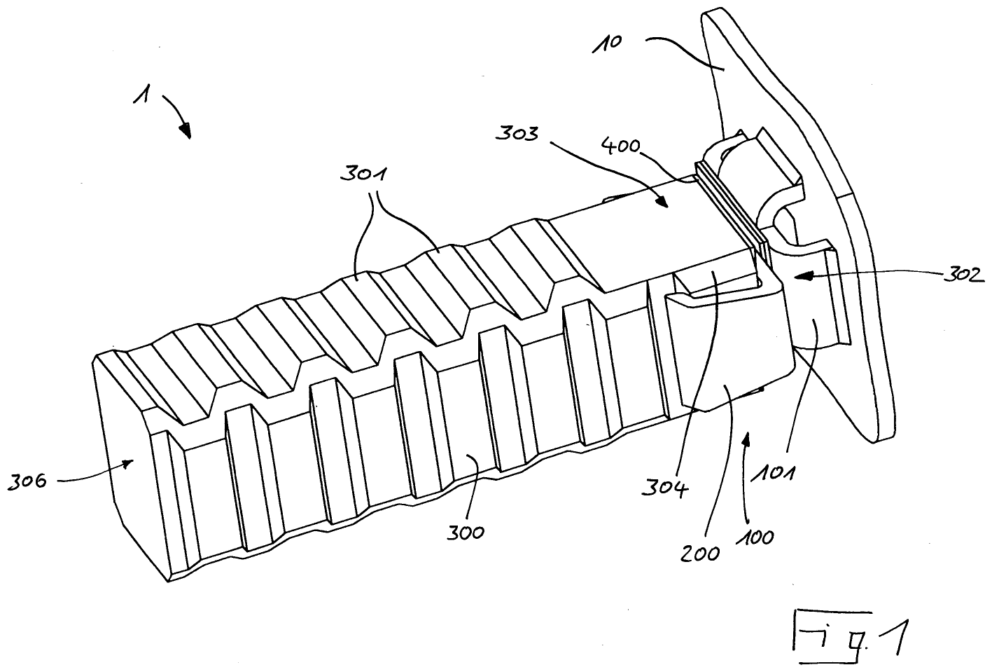

FIG. 1 an exemplary embodiment of a holding device according to the invention in a perspective view from above;

FIG. 2 a side view of the holding device according to FIG. 1;

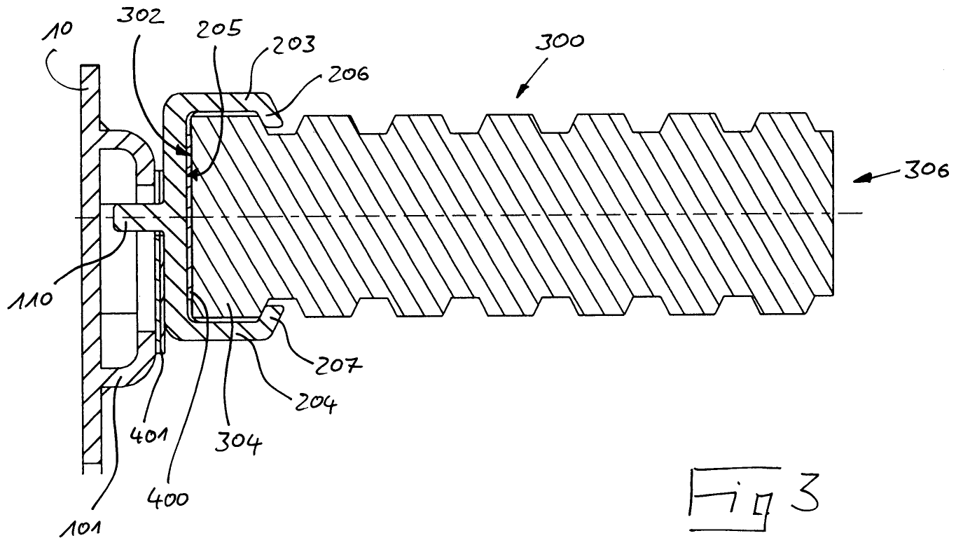

FIG. 3 the holding device according to FIG. 1 in a sectional view from above along the line of intersection J-J according to FIG. 2;

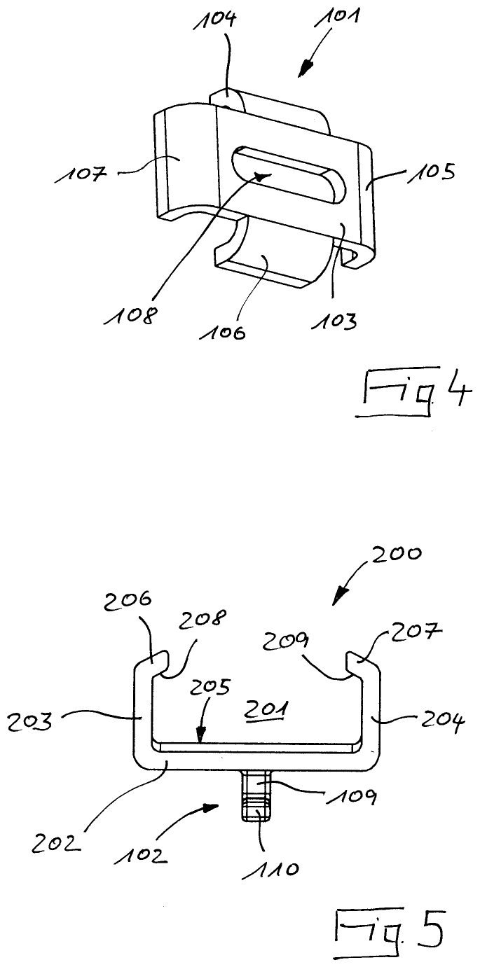

FIG. 4 a perspective view of the first fastening part of the holding device according to FIG. 1;

FIG. 5 the receiving part and the second fastening part of the holding device according to FIG. 1 in a view from above;

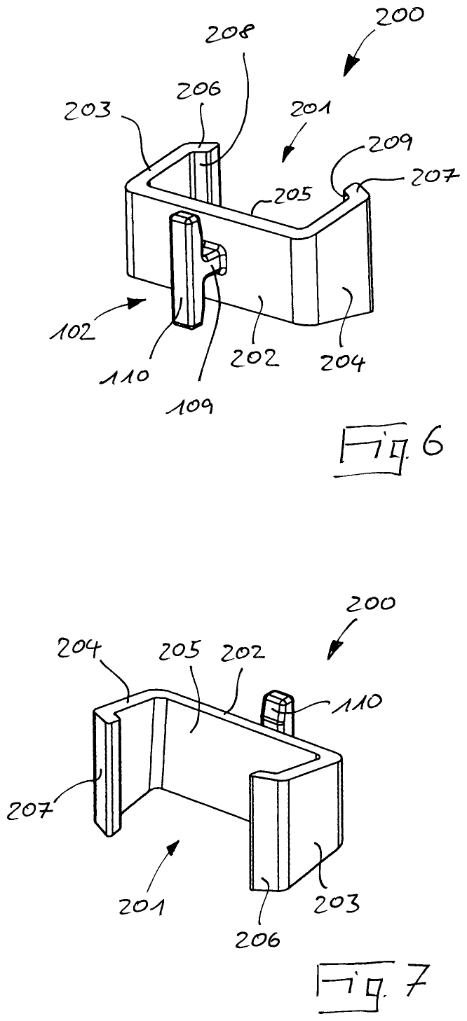

FIG. 6 the receiving part and the second fastening part of the holding device according to FIG. 1 in a perspective view from diagonally above;

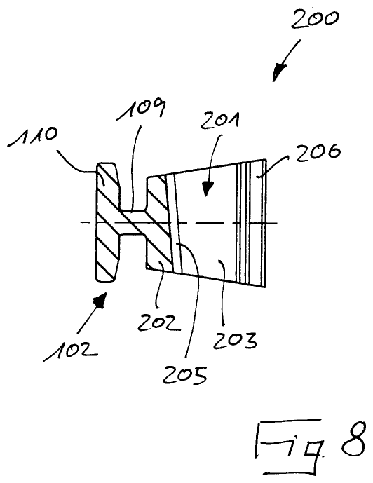

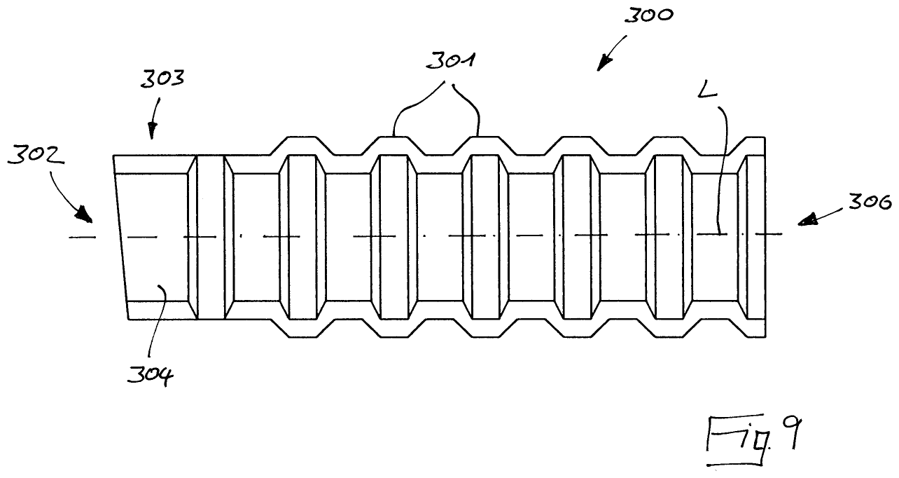

FIG. 7 the receiving part and the second fastening part of the holding device according to FIG. 1 in a further perspective view from diagonally above;

FIG. 8 a sectional side view of the receiving part and the second fastening part of the holding device according to FIG. 1;

FIG. 9 the anchor brick of the holding device according to FIG. 1 in a side view;

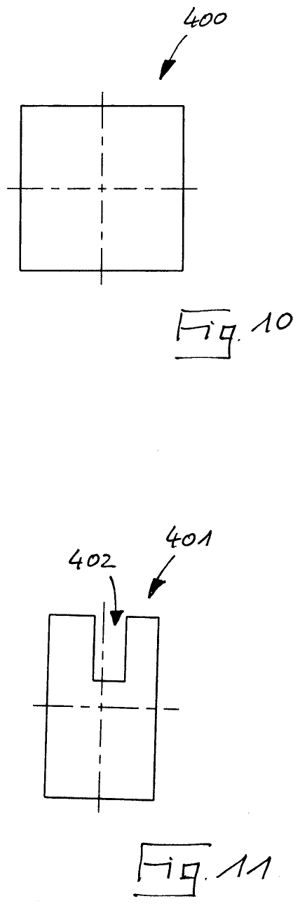

FIG. 10 a first fixing means in a top view; and

FIG. 11 a second fixing means in a top view.

In the figures, the holding device is indicated in its entirety by the reference sign 1. The holding device 1 comprises fastening means 100 for fastening the holding device 1 to a furnace wall 10, a receiving part 200 for holding a ceramic anchor brick 300 on the holding device 1, and a ceramic anchor brick 300.

The furnace wall 10, of which only a small section is shown, is made of steel.

The ceramic anchor brick 300 comprises a refractory ceramic material known for prior art ceramic anchor bricks. The ceramic anchor brick 300 extends along a longitudinal axis L from one end face 302 to an opposite, further end face 306 and has a substantially rectangular cross-sectional area perpendicular to the longitudinal axis L. The ceramic anchor brick 300 has a substantially rectangular cross-sectional area. The surface of the anchor block 300 is profiled by means of spaced longitudinal ribs 301 extending across each of the side surfaces of the anchor block 300 transverse to the longitudinal axis. A receiving section 303 of the ceramic anchor block 300 is formed adjacent the face 302 of the ceramic anchor brick 300. The receiving section 303 comprises the portion of the anchor brick 300 adjacent to the end face 302, wherein the receiving section 303 comprises two rib-like profilings flanking the end face 302 on two opposite side surfaces of the anchor brick, and one of the two rib-like profilings 304 can be seen in the figures; the other rib-like profiling is arranged symmetrically with respect to this rib-like profiling 304 on the opposite side of the anchor brick 300. The rib-like profilings 304 taper wedge-like in the same direction, in the arrangement of the retaining device according to FIG. 1 in each case downwards, i.e., in the direction of the action of gravity. Overall, the receiving section 303 thus has a substantially T-shaped configuration.

With the receiving section 303, the ceramic anchor brick 300 is received in a receptacle 201 of the receiving part 200. The receiving part 200 is formed as a one-piece steel part having a substantially C-shaped or claw-shaped configuration. In this regard, the receiving part 200 has a plate-shaped base section 202 with two legs 203, 204 arranged at opposite edges of the base section 202. The legs 203, 204 initially extend parallel to each other away from the base section 202 in the same direction and each have an end portion 206, 207 angled towards each other at their free end. The receptacle 201 is formed by the space enclosed by the base section 202 and the legs 203, 204. The base section 202 has a surface 205 facing the receptacle 201 and the end sections 206, 207 each have a surface 208, 209 facing the receptacle 201. The surfaces 208, 209 on the one hand and the surface 205 on the other hand approach each other in one direction—in the arrangement of the holding device 1 shown in FIG. 1 towards the bottom—resulting in a downwardly decreasing gap width of the receptacle 201. The legs 203, 204 engage around the receiving section 303.

The receiving section 303 is configured to form a positive fit with respect to the receptacle 201, and is also received in the receptacle 201 in a form-fit manner and, at the same time, in a frictional fit via a first fixing means 400 described in more detail below.

To hold the ceramic anchor brick 300 on the receiving part 200, the receiving part 200, as shown in FIG. 1, was arranged with a downwardly decreasing gap width of the receptacle 201 and the ceramic anchor brick 300 was then inserted with its receiving section 303 on top into the receptacle 201 until the receiving section 303, with the interposition of the first fixing means 400, is in full contact with the receptacle 201, whereby the receptacle 201 also acts to this extent as a stop for the receiving section 303. Subsequently, the anchor brick 300 is securely held in this position in the receiving part 200 due to gravity.

The receiving section 303 is frictionally retained in the receptacle 201 by a first fixing means 400. The first fixing means 400 is in the form of a 4 mm thick solid, and thus substantially non-compressible, plastic sheet made of polyethylene. In order to create the frictional connection, the first fixing means 400 has been arranged between the end face 302 of the ceramic anchor brick 300 and the surface 205 of the base section 202 facing the receptacle 201 during the insertion of the receiving section 303 into the receptacle 201, so that it is subsequently pressed between the end face 302 and the surface 205 when the receiving section 303 is located in the receptacle 201, thereby creating a frictional connection.

The fastening means 100 for fastening the holding device 1 to the furnace wall 10 comprise a first fastening part 101 and a second fastening part 102. The second fastening part 102 is designed in such a way that the latter can be form-fit fastened to the first fastening part 101 by a relative movement in the form of a rotary movement thereto.

The first fastening part 101 is formed as a one-piece steel member in a substantially bridge-like manner. The first fastening part 101 comprises a central, plate-shaped section 103 and, at its four edges, sections 104, 105, 106, 107 each extending away from the plate-shaped section 103 in the same direction, which are connected to the furnace wall 10 at their respective free ends via a welded joint. Through this, the plate-shaped section 103 of the first fastening part 101 is arranged on the furnace wall 10 at a distance therefrom. The plate-shaped section 103 has a slot 108 in the form of a horizontally extending elongated hole. Due to the distance of the plate-shaped section 103 from the furnace wall 10, the elongated hole is formed with an undercut.

The second fastening part 102 and the receiving part 200 are formed as a one-piece steel part. The second fastening part 102 is formed as a T-shaped insertion part which extends away from the base section 202 in the center of the base section 202 on the side of the base section 202 opposite the base section 202. The T-shaped insertion part of the second fastening part 102 has a base leg 109 extending away from the base section 202 and a transverse leg 110 extending transversely thereto at its distal end. The transverse leg 110 extends along the decreasing gap width of the receptacle 201, i.e., vertically in the arrangement of the holding device 1 according to FIG. 1.

The transverse leg 110 of the second fastening part 102 is dimensioned in such a way that it can be inserted into the slot 108 when it runs along the course of the slot 108 (i.e., rotated by 90° compared to the representation in the figures) and, after insertion, engages behind the undercut of the slot 108 by means of a relative movement in the form of a rotational movement through 90°, so that the second fastening part 102 can then no longer be pulled out of the slot 108 and is thus positively fastened to the latter. Subsequently, a solution of this fastening of the second fastening part 102 to the first fastening part 101 is only possible if the second fastening part 102 is again rotated by 90° in opposition to the first rotary movement and is subsequently pulled out of the elongated hole 108.

By means of a second fixing means 401, the second fastening part 102 is also frictionally fixed to the first fastening part 101 at the same time. The second fixing means 401 is present as a plate-shaped composite material having a thickness of 4 mm, wherein a bay-shaped recess 402 is formed in the composite material. The composite material comprises a plastic plate and a cardboard plate, each 2 mm thick, which lie flat on top of each other. The plastic plate is made of the same material as the first fixing means 400, and the cardboard plate is made of an elastically compressible cardboard. To produce the frictional connection, the second fixing means 401 was arranged between the plate-shaped portion 103 of the first fastening part 101 and the base portion 202 of the receiving part 200 during insertion of the transverse leg 110 and fixing of the second fastening part 102, so that the second fastening part 102 had to be inserted into the first fastening part 101 against the elastic force of the second fixing means 401, so that the second fixing means 401 is subsequently forced between the plate-shaped portion 103 and the base portion 202 after fixing, thereby producing a frictional connection.

The holding device shown in the figures is used to hold the refractory lining of a furnace in the form of an industrial furnace for the production of starting materials for the consumer goods industry at over 1,200° C.

To fasten multiple holding devices 1 to the furnace wall 10 of the industrial furnace, proceed as follows with respect to each of the holding devices:

The first fastening part 101 of the fastening means 100 is welded to the furnace wall 10 such that the elongated hole 108 extends horizontally.

The second fastening part 102 is positively and frictionally fastened to the first fastening part 101 with the interposition of the second fixing means 401, as explained above. In this fastened position of the second fastening part 102 to the first fastening part 101, the gap width of the gap of the receptacle 201 is reduced downward.

To hold the ceramic anchor brick 300 to the receiving part 200, the receiving section 303 of the ceramic anchor brick 300 is positively and frictionally fixed to the receptacle 201 with the interposition of the first fixing means 400, as explained above.

A refractory lining of the furnace can then be held on a number of holding devices 1 fastened to the furnace wall 10 accordingly.

During furnace operation, the first and second fixing means 400, 401 lose their frictional effect as the cardboard of the second fixing means 401 ignites and the plastic of the first and second fixing means 400, 401 melts. This increases the mobility of the holding device 1, as explained above, so that thermal expansions can be absorbed particularly well by the holding device. Nevertheless, even if the lining is removed at a later stage, the fixing of the anchor brick 300 to the receptacle 201 and of the second fastening part 102 to the first fastening part 101 is maintained.

1. Holding device (1) for holding a ceramic anchor brick (300) on a furnace wall (10), the holding device (1) comprising:
1.1 fastening means (100) for fastening the holding device (1) to a furnace wall (10);
1.2 a receiving part (200) for holding a ceramic anchor brick (300) on the holding device (1);
1.3 wherein the fastening means (100) comprises a first fastening part (101) and a second fastening part (102), wherein
1.3.1 the first fastening part (101) is fastenable to a furnace wall (10), and
1.3.2 the second fastening part (102) is fastened to the receiving part (200), and wherein
1.3.3 the second fastening part (102) is fastenable to the first fastening part (101); wherein
1.4 the first fastening part (101) and the second fastening part (102) are designed in such a way that the second fastening part (102) is fastenable to the first fastening part (101) by a relative movement of the second fastening part (102) to the first fastening part (101);
characterized in that
the relative movement is a rotary movement.

2. Holding device (1) according to claim 1, wherein the first fastening part (101) is formed in one piece.

3. Holding device (1) according to at least one of the preceding claims, wherein the second fastening part (102) is formed in one piece.

4. Holding device (1) according to at least one of the preceding claims, wherein the second fastening part (102) and the receiving part (200) are formed together in one piece.

5. Holding device (1) according to at least one of the preceding claims, wherein the first fastening part (101) has an insertion opening (108) and the second fastening part (102) has an insertion section (110) which can be inserted into the insertion opening (108), and wherein the second fastening part (102) can be form-fit fastened to the first fastening part (101) via the insertion section (110) inserted into the insertion opening (108) by the relative movement of the second fastening part (102).

6. Holding device (1) according to claim 5, wherein the insertion opening (108) is a slot with undercut.

7. Holding device (1) according to claim 6, wherein the insertion section (110) can be inserted into the slot and the relative movement can engage behind the undercut.

8. Holding device (1) according to at least one of the preceding claims, wherein the second fastening part (102) can be positively fastened to the first fastening part (101) by the relative movement.

9. Holding device (1) according to at least one of the preceding claims, wherein the second fastening part (102) can be frictionally fastened to the first fastening part (101) by the relative movement.

10. Holding device (1) according to claim 9, wherein the second fastening part (102) can be frictionally fastened to the first fastening part (101) by a fixing means (401).

11. Furnace, comprising the following features:
11.1 a furnace wall (10),
11.2 one or more holding devices (1) according to at least one of the preceding claims, wherein the holding devices (1) are each fastened to the furnace wall (10) via the fastening means (100).

12. Method of fastening a holding device (1) according to at least one of claims 1 to 10 to a furnace wall (10) of a furnace, comprising the following steps:
A. fastening the first fastening part (101) to the furnace wall (10);
C. performing a rotary movement of the second fastening part (102) relative to the first fastening part (101) to fasten the second fastening part (102) to the first fastening part (101).

13. Method according to claim 12, comprising the following further step after process step A and before process step C:
B. receiving the second fastening part (102) in the first fastening part (101).

14. Method of claim 13, wherein the second fastening part (102) is received in the first fastening part (101) by inserting the second fastening part (102) into the first fasting part (101).
